(19) United States
(12) Patent Application Publication
(10) Pub. No.: US 2007/0098091 A1
(43) Pub. Date: May 3, 2007

(54) Method and system for residual frequency offset compensation of multi-carrier communication system

(75) Inventor: Wen-Sheng Hou, Chungli City (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: Silicon Integrated Systems Corp., Hsin-Chu (TW)

(21) Appl. No.: 11/262,121

(22) Filed: Oct. 28, 2005

(51) Int. Cl. H04K 1/10

(52) U.S. Cl. 375/260

(57) ABSTRACT

A residual frequency offset (RFO) compensation method and a compensation system of a multi-carrier communication system is disclosed. The compensatory method of present invention includes two phase-computation steps. The first phase-computation step processes a phase variation of an OFDM data symbol each time to obtain a RFO estimation for compensating a demodulation carrier. The second-phase computation processes a plurality of OFDM data symbols each time to obtain a RFO estimation for compensating the demodulation carrier. The compensation system of the present invention includes: a Discrete Fourier Transformation (DFT) unit for performing DFT on receiving OFDM packages; a phase variation detector connecting to the DFT unit for detecting phase variations of a plurality of OFDM data symbols; and a residual frequency offset compensator connecting to the phase variation detector, which generates the desired RFO estimations in accordance with the phase variations of the plurality of OFDM data symbols and the compensation method of the present invention.

### 1. FIELD OF THE INVENTION

The present invention relates generally to a multi-carrier communication system, and more specifically, to a RFO (residual frequency offset) compensation method and system of OFDM (Orthogonal Frequency Division Multiplexing).

### 2. DESCRIPTION OF THE PRIOR ART

Frequency division multiplexing (FDM) is a technology that transmits multiple signals simultaneously over a cable or wireless system. Each signal travels within its own unique frequency range (sub-carrier), which is modulated by the data. OFDM is based on and similar to FDM, but much more spectrally efficient by spacing the sub-channels much closer together. This is done by finding frequencies that are orthogonal, allowing the spectrum of each sub-channel to overlap another without interfering with it. The effect of this is that the required bandwidth has greatly reduced. Therefore, OFDM has been recognized as an excellent method for high-speed bi-directional wireless data communication. Today, the technology is used in such systems as asymmetric digital subscriber line (ADSL) as well as wireless systems, moreover, it is also currently one of the prime technologies being considered for use in future fourth generation (4G) networks.

The inverse discrete Fourier transform (IDFT) and the discrete Fourier transform (DFT) of OFDM are used for modulating and demodulating the data constellations on the orthogonal sub-carriers, and in practice are implemented as Inverse Fast Fourier Transforms (IFFT) and Fast Fourier Transforms (FFT), respectively. The OFDM system treats the source symbols at a transmitter as though they are in the frequency-domain. The IFFT takes in N symbols at a time where N is the number of sub-carriers in the system, and modulating data onto N orthogonal sub-carriers via IDFT. After Parallel/Serial Conversion, the time-domain signal that results from the IFFT is transmitted across the channel that is supplied via a local oscillator (LO). At the receiver, a demodulation carrier with same frequency is produced via a LO to receive the signal, and DFT demodulating the data constellations and bring it into the frequency domain.

The LO frequency at the receiver is typically different from the LO frequency at the transmitter, thus carrier frequency offsets (CFO) are typically introduced by a small frequency mismatch in the local oscillators of the transmitter and the receiver. To help the receiver accomplish synchronized reception a known data sequence, the preamble, is transmitted at the beginning of each packet, and it can be used for CFO estimation. However, due to the variance of the preamble, it causes a residual frequency offset (RFO) between the CFO estimation and the real CFO. If the CFO is not completely corrected, a slow rotation with time will occur, and result in inter-carrier interference (ICI) effect in the receiver side, consequently rising the erroneous rate of packet. By using a known pilot sub-carrier, which are generated by the IFFT and can be used to provide a stable phase reference for the receiver circuitry, hence the rotation can be estimated and compensated.

As shown in FIG. 1, a carrier-tracking loop is used to adjust the LO frequency of the receiver. A frequency offset F1 is estimated from the preamble, a LO 100 generates a demodulation-carrier with frequency F and compensated by F1, then the OFDM data symbol is demodulated by a DFT unit 102. The output of DFT unit is coupled to post calculator as well as a phase variation detector 104 to check the phase according a pilot tone reference. The phase variation is transmitted to the post calculator and a RFO calculator 106, and a RFO estimation F2 is generated as an additional feedback to demodulation-carrier, thus the carrier frequency F+F1 has turn into F+F1+F2.

FIG. 2 is the phase variation vs. OFDM data symbol diagram under a same demodulation-carrier. By ignoring the noise, these points can fit to a linear line with a slope, and the slope will be the RFO estimation. Each of N input symbols has a symbol period of T seconds, and θ(n) is the phase variation of nth data symbol. Let n=0 as a basis, the RFO estimation is calculated by the phase variation of the nth symbol,

$$F 2 = \frac{θ ( n )}{n \times T}$$

Alternatively, θ(n) and θ(m) denote the phase variation of ith and the mth symbol, and the RFO estimation can be calculated by:

$$F 2 = \frac{θ ( m ) - θ ( i )}{( m - i ) \times T}$$

The number of samples n or the time interval between the ith symbol and the mth symbol will affect the accuracy of the estimation. While the number of samples n is getting larger, the denominator is also larger. Thus the accuracy will be higher, but the compensation velocity will get slower. For example, if take n being 5, the first to fifth symbols will not be compensated by the estimated RFO, which start to compensate the sixth symbol, the seventh symbol and so on, and the erroneous rate of packet cannot decrease effectively. If take n being 2, there just the first and the second symbol will not be compensated. However, due to the shorter time interval, the phase variation of second symbol dominants the RFO estimation, which will be not accurate enough to get a good compensation.

Therefore, it would be an advantageous to have an accurate and quick compensatory method at receiver side that to calculate the RFO estimation to lower the ICI effects.

### SUMMARY OF THE INVENTION

It is therefore a general object of the present invention to provide a compensatory method for residual frequency compensation of multi-carrier communication system to early compensate the demodulation-carrier by feeding back the RFO estimation.

It is another object of the present invention to provide a compensatory method for further compensating the demodulation-carrier by fine adjusting the RFO estimation, after the first RFO estimation is done at the first several symbols.

According to the objects, the present invention provides a compensatory method that includes two phase-computation steps. The first phase-computation step processes a phase variation of an OFDM data symbol (also referred as data symbol, symbol) each time to obtain RFO estimation for compensating a demodulation carrier. The second-phase computation processes a plurality of OFDM data symbols each time to obtain RFO estimation for compensating the demodulation carrier. The compensation system of the present invention includes: a Discrete Fourier Transformation (DFT) unit for performing DFT on receiving OFDM packets; a phase variation detector coupling to the DFT unit for detecting phase variations of a plurality of OFDM data symbols; and a residual frequency offset calculator coupling to the phase variation detector, which generates the desired RFO estimation in accordance with the phase variations of the plurality of OFDM data symbols and the compensatory method of the present invention.

### BRIEF DESCRIPTION OF THE DRAWINGS

FIG. 1 shows the general structure of a receiver of an OFDM communication system.

FIG. 2 illustrates diagramed the relationship between the OFDM data symbols and the phase variance.

FIG. 3 illustrates diagramed the RFO estimation of the first step of one embodiment of this invention.

FIG. 4 illustrates diagramed the RFO estimation of the second step of one embodiment of this invention.

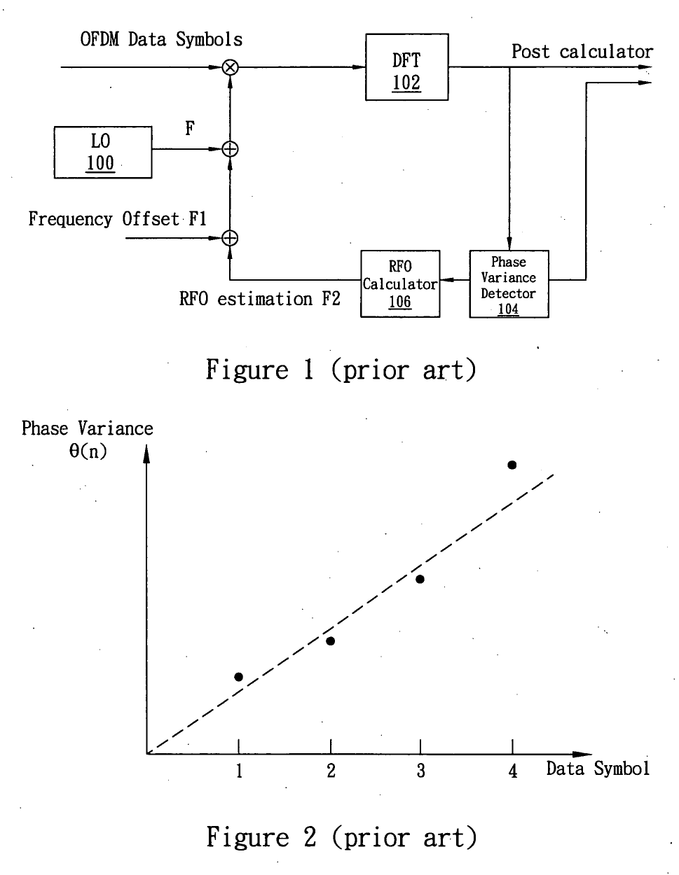

### DESCRIPTION OF THE PREFERRED EMBODIMENT

According to present invention, the RFO estimation is carried out into two successive steps. In order to avoid the ICI effects, the key of first step is the velocity of compensation. And the second step will focus on the accuracy of compensation.

As is well known in the art, the kth symbol is selected to proceed to a first RFO compensation, thus the first symbol to the kth symbol will be demodulated via a demodulation-carrier without compensation, and will cause serious ICI effects. However, the first step of this invention is capable of compensating the symbols that before the kth symbol, in addition, it is capable of getting the same estimation as used method.

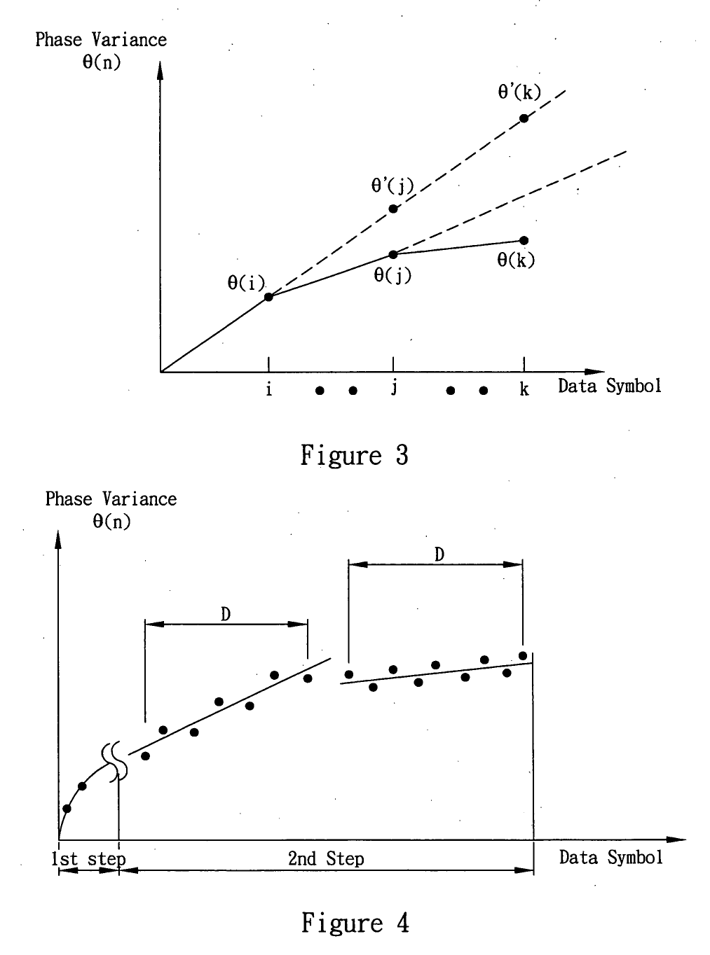

FIG. 3 illustrates diagramed the RFO estimation of the first step of one embodiment of this invention. If the symbols are demodulated with an initially and invariably compensatory carrier F+F1, thus the estimation of phase variation of the jth and kth are respectively θ′(j) and θ′(k). However, compensating each symbol of the invention causes a nonlinear relationship between the phase variation and the data symbols. The slopes of curve are gradually decreasing to zero, and the RFO equals zero while the slope equals to zero. In other words, the carrier of receiver and the carrier of transmitter are modulated/demodulated with same frequency at the moment.

According to the invention, the symbols will be demodulated via a demodulation-carrier with frequency F+F1 from the end of the preamble to the ith symbol. The estimated phase variation of the ith symbol is θ(i), thus the RFO estimation of the ith symbol F2_i is,

$$F 2 \_i = \frac{θ ( i )}{i \times T}$$

And the carrier frequency to demodulate will change to F+F1+F2_i, thus the RFO estimation of the jth symbol F2_j is,

$$F 2 \_j = \frac{{θ}^{′} ( j )}{j \times T}$$

The difference of phase variation estimation between θ′(j) and θ(j) is due to a different estimation estimated from the I+1th symbol to the jth symbol. The phase variation between the I+1 symbol to the jth symbol is (F2_i)×(j−i)T, thus the θ′(j) is,
θ′(j)=θ(j)+(F2_{—}i)×(j−i)T

And the adjusted RFO estimation F2_j is,

$$F 2 \_j = \frac{{θ}^{′} ( j )}{j \times T} = \frac{θ ( j ) + ( F 2 \_i ) \times ( j - i ) T}{j \times T} = \frac{θ ( j ) + \frac{θ ( i )}{i T} x ( j - i ) T}{j \times T}$$

And consequently the frequency of demodulation-carrier will change to F+F1+F2_j.

According to the same theory to estimate the RFO for the kth symbol, and get a estimated RFO of the kth symbol θ(k). The difference phase variation estimation between θ′(k) and θ(k) is due to a different estimation estimated from the i+1th symbol to the jth symbol calculated as (F2_i)×(j−i)T, and a different estimation estimated from the j+1 th symbol to the kth symbol calculated as (F2_j)×(k−j)T, thus the θ′(k) is,
θ′(k)=θ(k)+(F2_{—}i)×(j−i)T+(F2_{—}j)×(k−j)T

And the adjusted RFO estimation F2_k is,

$$\begin{matrix}F 2 \_k = \frac{{θ}^{′} ( k )}{k \times T} = \frac{θ ( k ) + ( F 2 \_i ) \times ( j - i ) T + ( F 2 \_j ) \times ( k - j ) T}{k \times T} \\ = \frac{θ ( k ) + \frac{θ ( i )}{i T} x ( j - i ) T + ( \frac{θ ( j ) + \frac{θ ( i )}{i T} x ( j - i ) T}{j \times T} ) \times ( k - j ) T}{k \times T}\end{matrix}$$

It is appreciated that if we demodulate via a demodulation-carrier with initial frequency F+F1 and start to compensate at the kth symbol, a same F2_k result will get as hereinbefore.

The estimation of first step of the invention can be shown a sequence as follows:
1 detect the phase variation of the ith symbol to estimate a RFO estimation F2,

$$F 2 = \frac{θ ( i )}{i \times T}$$
2 compensate the demodulation-carrier with feedback F2.
3 detect the phase variation of the jth symbol to estimate a newer RFO estimation F2,

$$F 2 = \frac{{θ}^{′} ( j )}{j \times T} = \frac{θ ( j ) + \frac{θ ( i )}{i T} x ( j - i ) T}{j \times T}$$
4 compensate the demodulation carrier with feedback F2.
5 detect the phase variation of the kth symbol to estimate a newer RFO estimation F2,

$$F 2 = \frac{{θ}^{′} ( k )}{k \times T} = \frac{θ ( k ) + \frac{θ ( i )}{i T} x ( j - i ) T + ( \frac{θ ( j ) + \frac{θ ( i )}{i T} x ( j - i ) T}{j \times T} ) \times ( k - j ) T}{k \times T}$$
6 compensate the demodulation carrier with feedback F2.

It is practicable that not limit the times of compensation to three, while more times of compensation cause more memory be occupied. In addition, it is also practicable the estimated RFO is adjusted per symbol. A prefer embodiment to choose the first three symbols for the RFO estimation of first step, e.g. i, j, k are 1, 2, 3 respectively. According to the method of first step of present invention, the first several symbols can be compensated in time thus reducing the ICI effects.

After estimating RFO by the first step, the remaining frequency offset is estimated by the second step till the end of the packet. Larger samples will be selected, as the remaining RFO is small. FIG. 4 shows a method embodiment of second step of the invention. The estimation is taken at d symbols interval. Assuming the estimation is taken on the nth symbol, the difference of estimation of phase variation between the (n+d)th symbol and the nth symbol Φ is,
φ=θ(n+d)−θ(n)

Thus the RFO estimation F2 is,

$$F 2 = F 2 + \frac{θ ( n + d ) - θ ( n )}{d \times T}$$

If larger d is selected, the compensatory performance will be better in the low SNR environment. In addition, the size of interval d is not limited and even a variable d is also practicable in this invention. Moreover, a straight line that fit by a linear regression such as a least mean square method can also to calculate the phase variation.

Generally, after compensation of the first step, the slope of second step shown in FIG. 4 shall much smaller than the slope of the first step, i.e., θ(n+d)≈θ(n). However, the calculation of phase limits |θ(n)|≦π, thus the relationship may change to θ(n+d)≈θ(n)+2πi, i ε{−1,0,1} even though θ(n+d)≈θ(n). It is necessary to remove the 2πi. The method is to determine whether the 2πi is added or not, according to whether the difference between θ(n+d) and θ(n) is larger than π or not, that is,
φ=θ(n+d)−θ(n)2πi, i is −1, 0 or 1.
If |θ(n+d)−θ(n)|>π,
then i=sign {θ(n+d)−θ(n)}
otherwise i=0.

After estimation of the two steps of embodiments described hereinbefore, the RFO could be quick and accurate compensated to decrease the ICI effects, thus increasing the efficiency of the receiver.

While the invention has been described in conjunction with a specific mode, a number of variations may be made according to present invention. Therefore, it will be appreciated by those skilled in the art that various modifications, alternatives and variations may be made without departing from the scope of the present invention, which is intended to be limited solely by the appended claims.

What is claimed is:

1. A method for compensation of residual-frequency-offset (RFO) of multi-carrier communication system, comprising:
proceeding a first step estimation to calculate a first RFO estimation to be a feedback to compensate a demodulation carrier, wherein said first RFO estimation is calculated by a phase variation estimation taken at each symbol and equals a RFO estimation that is estimated by a phase variation estimation taken at current symbol; and
proceeding a second step estimation to calculate a second RFO estimation to further compensate said demodulation carrier, wherein said second RFO estimation is calculated by a phase variation estimation taken at a plurality of symbols interval.

2. The method for compensation as set forth in claim 1, wherein said current symbol and said a plurality of symbols include Orthogonal Frequency Division Multiplexing (OFDM) data symbol.

3. The method for compensation as set forth in claim 1, wherein said first step estimation comprises three calculations:
detecting the phase variation of the ith symbol θ(i) to estimate a RFO estimation F2 according the equation
$$F 2 = \frac{θ ( i )}{i \times T}$$
to compensate the demodulation-carrier;
detecting the phase variation of the jth symbol θ(j) to estimate a newer RFO estimation F2 according to the equation
$$F 2 = \frac{{θ}^{′} ( j )}{j \times T} = \frac{θ ( j ) + \frac{θ ( i )}{i T} x ( j - i ) T}{j \times T}$$
to compensate the demodulation carrier; and
detecting the phase variation of the kth symbol θ(k) to estimate a newer RFO estimation F2 according to the equation
$$F 2 = \frac{{θ}^{′} ( k )}{k \times T} = \frac{θ ( k ) + \frac{θ ( i )}{i T} x ( j - i ) T + ( \frac{θ ( j ) + \frac{θ ( i )}{i T} x ( j - i ) T}{j \times T} ) \times ( k - j ) T}{k \times T}$$
to compensate the demodulation carrier;
wherein T is time period of each of said plurality of symbols.

4. The method for compensation as set forth in claim 1, wherein said phase variation estimation is to calculate the offset from a reference symbol, which is a pilot tone inserted in the preamble.

5. The method for compensation as set forth in claim 1, wherein said RFO estimation is initiated by calculating the preamble of a packet to be initial value of RFO estimation.

6. The method for compensation as set forth in claim 1, wherein said second step estimation is calculated by subtracting the phase variation of the last symbol of said plurality of symbols from the phase variation of the first symbol of said plurality of symbols then dividing by the time interval of said plurality of symbols.

7. The method for compensation as set forth in claim 6, wherein said second step estimation is calculated by this equation
$$F 2 = F 2 + \frac{θ ( n + d ) - θ ( n )}{d \times T}$$
to get said second RFO estimation F2, wherein θ(n) is the phase variation of the nth symbol; θ(n+d) is the phase variation of the (n+d)th symbol; T is the time period of said plurality of symbols; d is the number of said plurality of symbols.

8. The method for compensation as set forth in claim 7, wherein said phase variation between the (n+d)th symbol and the nth symbol i.e. θ(n+d)−θ(n) is subtracted by 2π if said phase variation is larger than π, and is added by 2π if said phase variation is smaller than −π.

9. A system for compensation of residual-frequency-offset (RFO) of multi-carrier communication system, to process a packed signals by two step estimation, comprising:
a discrete Fourier transform (DFT) unit to receive said packed signals to proceed discrete Fourier transform;
a phase variation detector connected to said DFT to detect a phase variation from a plurality of symbols of said packed signals; and
a residual frequency offset (RFO) calculator coupled to said phase variation detector to calculate a RFO estimation according to said phase variation.

10. The RFO compensatory system as set forth in claim 9, wherein said a plurality of symbols include Orthogonal Frequency Division Multiplexing (OFDM) data symbol.

11. The RFO compensatory system as set forth in claim 9, wherein said RFO calculator calculates a first RFO estimation during the first step estimation to be a feedback to compensate a demodulation carrier according to a phase variation estimation calculated from each phase variation of said plurality of symbols and equals a RFO estimation that is estimated by a phase variation estimation taken at current symbol.

12. The RFO compensatory system as set forth in claim 9, wherein said first step estimation comprises three calculation:
detecting the phase variation of the ith symbol θ(i) to estimate a RFO estimation F2 according the equation
$$F 2 = \frac{θ ( i )}{i \times T}$$
to compensate the demodulation carrier;
detecting the phase variation of the jth symbol θ(j) to estimate a newer RFO estimation F2 according to the equation
$$F 2 = \frac{{θ}^{′} ( j )}{j \times T} = \frac{θ ( j ) + \frac{θ ( i )}{i T} x ( j - i ) T}{j \times T}$$
to compensate the demodulation carrier; and
detecting the phase variation of the kth symbol θ(k) to estimate a newer RFO F2 according to the equation
$$F 2 = \frac{{θ}^{′} ( k )}{k \times T} = \frac{θ ( k ) + \frac{θ ( i )}{i T} x ( j - i ) T + ( \frac{θ ( j ) + \frac{θ ( i )}{i T} \times ( j - i ) T}{j \times T} ) \times ( k - j ) T}{k \times T}$$
to compensate the demodulation carrier;
wherein T is time period of said plurality of symbols.

13. The RFO compensatory system as set forth in claim 9, wherein said RFO calculator calculates a second RFO estimation during the second step estimation to be a feedback to compensate a demodulation carrier according to said phase variation calculated from said plurality of symbols.

14. The RFO compensatory system as set forth in claim 13, wherein said second step estimation is calculated by subtracting the phase variation of the last symbol of said plurality of symbols from the phase variation of the first symbol of said plurality of symbols then dividing by the time interval of said plurality of symbols.

15. The RFO compensatory system as set forth in claim 13, wherein said second step estimation is calculated by this equation
$$F 2 = F 2 + \frac{θ ( n + d ) - θ ( n )}{d \times T}$$
to get said second RFO estimation F2, wherein θ(n) is the phase variation of the nth symbol; θ(n+d) is the phase variation of the (n+d)th symbol; T is the time period of said plurality of symbols; d is the number of said plurality of symbols.

16. The RFO compensatory system as set forth in claim 15, wherein said phase variation between the (n+d)th symbol and the nth symbol i.e. θ(n+d)−θ(n) is subtracted by 2π if said phase variation is larger than π, and is added by 2π if said phase variation is smaller than −π.

17. The RFO compensatory system as set forth in claim 9, wherein said phase variation estimation is to calculate the offset from a reference symbol, which is a pilot tone inserted in the preamble.

18. The RFO compensatory system as set forth in claim 9, wherein said RFO estimation is initiated by calculating the preamble of a packet to be initial value of RFO estimation.
